(19) United States
(12) Patent Application Publication
(10) Pub. No.: US 2003/0095044 A1
(43) Pub. Date: May 22, 2003

(54) Security apparatus and method for a mobile electronic system

(75) Inventors: Ming-Hsien Lin, Shijr City (TW); Shih-Chin Lai, Shijr City (TW); Chu-Chia Tsai, Shijr City (TW)

Correspondence Address: Richard P. Berg, Esq., c/o LADAS & PARRY, Suite 2100, 5670 Wilshire Boulevard, Los Angeles, CA, 90036-5679, US

(73) Assignee: Acer Inc.

(21) Appl. No.: 10/057,426

(22) Filed: Jan. 25, 2002

(30) Foreign Application Priority Data
Nov. 16, 2001 (TW) 90128527

(51) Int. Cl. G08B 13/12

(52) U.S. Cl. 340/568.2; 340/539.21

(57) ABSTRACT

A security apparatus for a mobile electronic system, comprising a remote controller and a receiver. When the mobile electronic system is turned off and the control module is unable to establish a wireless connection to the receiver within a first time period, the remote controller activates an alarm module. When the mobile electronic system is turned on and the receiver is able to establish a wireless connection to the remote controller, the mobile electronic system enables access, wherein the remote controller comprises a control key, which is able to disable wireless function of the security apparatus.

### BACKGROUND OF THE INVENTION

1. Field of the Invention

The present invention relates to a security apparatus and method for a mobile electronic system. In particular, the present invention relates to a security apparatus and method for a mobile electronic system using wireless transmission.

2. Description of the Related Art

Business travelers frequently use mobile electronic systems such as notebook computers (NB) or personal digital assistants (PDA). These devices present very real security issues, especially for those traveling abroad, and for those whose devices contain valuable information.

### SUMMARY OF THE INVENTION

Accordingly, the present invention provides a security apparatus, which has a receiver and a remote controller connected to each other using wireless transmission. When the mobile electronic system with the wireless security apparatus is turned off and the remote controller is unable to establish a wireless connection to the receiver within a first time period, the remote controller activates an alarm module located thereon. When the mobile electronic system is turned on and the receiver is unable to establish a wireless connection to the remote controller, the mobile electronic system disables access to the mobile electronic system. The remote controller comprises a control key to deactivate wireless transmission for the security apparatus, disabling any wireless signals.

To achieve the aforementioned goal, the present invention provides a wireless security apparatus, coupled to a mobile electronic system such as a notebook or PDA. The wireless security apparatus comprises a receiver connected to a mobile electronic system and a remote controller. The receiver and the remote controller are able to establish a wireless connection. The wireless transmission protocol can be Bluetooth or other protocol and its effective range is 10 meters. The remote controller also comprises a control module and an alarm module such as a security lamp, a speaker or a vibrator, such that when the control module is unable to establish a wireless connection to the receiver within a first time period, the control module activates the alarm module. Similarly, when the mobile electronic system is turned on and the receiver is able to establish a wireless connection to the remote controller, the mobile electronic system enables access. When the mobile electronic system is turned on and the receiver is unable to establish a wireless connection to the remote controller within a second time period, the mobile electronic system disables access to the mobile electronic system, wherein the remote controller is able to suspend wireless function.

Furthermore, the present invention also provides a wireless security method for a security apparatus of a mobile electronic system, wherein a receiver coupled to the mobile electronic system and a receiver of the security apparatus are able to establish a wireless connection. The security method comprises the steps of the remote controller sending a search packet to the receiver by the wireless transmission. The receiver sends a feedback packet in response to the search packet. If the remote controller is unable to receive the feedback packet within a first time period, the remote controller produces an alarm action such as lighting a lamp, producing a sound or a vibration. When the mobile electronic system is turned on and the receiver is able to receive the search packet, the mobile electronic system enables access. When the mobile electronic system is turned on and the receiver is unable to receive the feedback packet within a second time period, the mobile electronic system disables access to the mobile electronic system, wherein the remote controller turns off the wireless function and disables any wireless signal.

### BRIEF DESCRIPTION OF THE DRAWINGS

These and other features, aspects, and advantage of the present invention will become better understood with reference to the following description, appended claims and accompanying diagrams where:

FIG. 1 is a schematic structural diagram of the wireless security apparatus and the notebook computer of the present invention;

FIG. 2 is a block diagram of a wireless security apparatus of the present invention;

FIG. 3 is a flow diagram of the wireless security apparatus of an embodiment of the present invention;

FIG. 4 is a flow diagram of the a wireless security apparatus of another embodiment in the present invention;

### DETAILED DESCRIPTION OF THE INVENTION

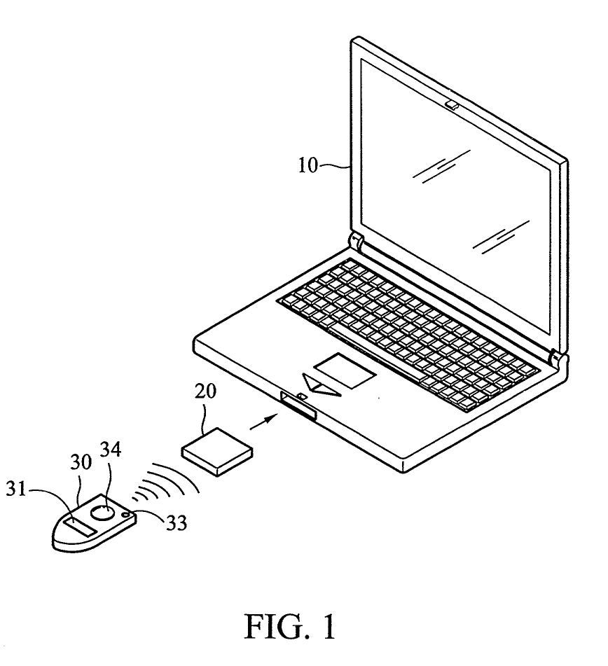

FIG. 1 is a schematic structural diagram of the wireless security apparatus and the notebook computer of the present invention. In FIG. 1, the security apparatus is divided into two parts, one is a receiver (20) of the security apparatus and the other is a remote controller (30) of the security apparatus. Both transmit data through wireless transmission. Furthermore, the receiver (20) of the security apparatus is designed as a module, which is able to be set up in the notebook computer (10).

There is an “In Range” security lamp (33) on the remote controller (30), indicating that the receiver (20) and the remote controller (30) of the security apparatus are in effective range for wireless transmission. When the notebook computer (10) is in the effective wireless range, the security system effectively safeguards it from theft. The security lamp (33) is a kind of alarm module (34). When the receiver (20) and the remote controller (30) of the security apparatus are unable to transmit wireless data, that is, when the notebook computer (10) is outside the effective wireless range, the security lamp (33) will light or flash, reminding the user that the notebook computer (10) is outside the secure region. The alarm module (34) can be a speaker or vibrator, also alerting the user.

On the remote controller (30) of the security apparatus, there is also a control key (31), which is able to disable the remote controller's (30) wireless function. As an example, users traveling by plane with the notebook computer (10) use this control key (31) to temporarily disable wireless function to avoid interfering with flight safety. The user is able to restore wireless function after disembarking to reduce the chance of the notebook computer (10) being stolen within the airport.

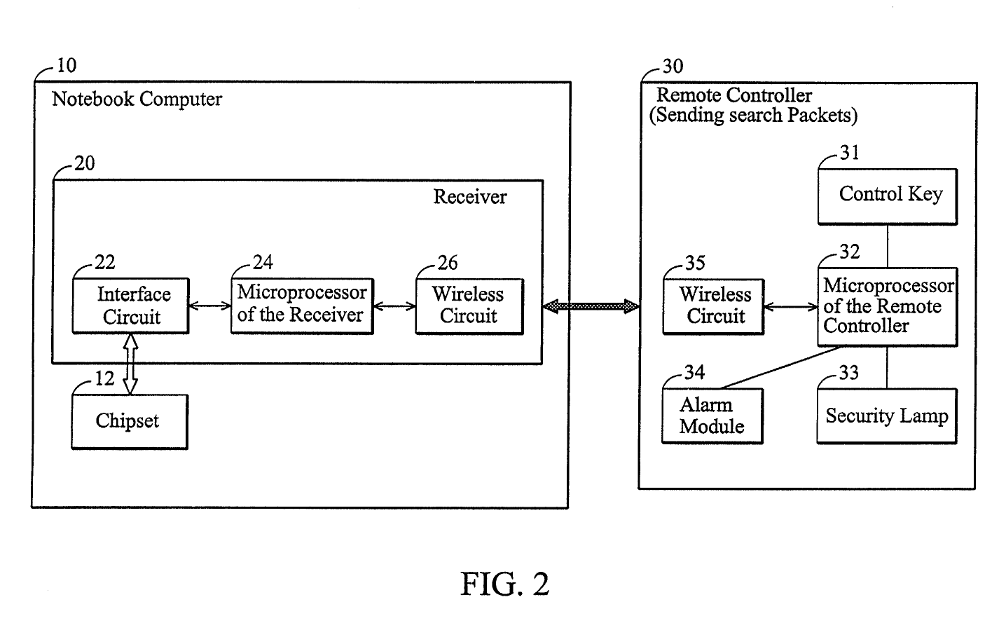

FIG. 2 is a block diagram of a wireless security apparatus according to the present invention. In FIG. 2, an interface circuit (22) in the receiver (20) of the security apparatus is coupled with the chipset (12) in the notebook computer. The interface circuit (22) is able to transmit the data from the receiver (20) of the security apparatus to the notebook computer. The data is used to control the notebook computer. For example, the receiver (20) is coupled to the chipset in the notebook computer through the interface circuit (22). In different situations, the receiver (20) is able to lock the keyboard of the notebook computer, shut down the LCD, disable access to the notebook computer or turn on/off the notebook computer by different control commands. Moreover, in order to prevent disclosure of confidential information, the receiver (20) is also able to format the hard disk through dedicated software and hardware.

Referring to FIG. 2, in the embodiment of the present invention, there are microprocessors both in the receiver (20) and in the remote controller (30) of the security apparatus. Both of the microprocessors are control ICs such as 8051 or simpler microprocessors, which is able to produce data packets transmitted by the wireless circuit (26) in the receiver (20) and the wireless circuit (35) in the remote controller (30). The microprocessor (24) of the receiver (20) is able to identify a remote controller identity code included in the search packet and the microprocessor (32) of the remote controller (30) also is able to identify a receiver identity code included in the feedback packet. If the identity codes are not correct, the packets are treated as invalid packets. The microprocessors (24,32) of the receiver (20) and the remote controller (30) take no action until receipt of the correct remote controller identity code and the correct receiver identity code and then execute the predetermined process. Moreover, in the embodiment of the present invention, the wireless circuits (26,35) in the receiver (20) and the remote controller (30) use wireless transmission to transmit data, such as the well-known Bluetooth protocol or others. Considering the security problem, the effective wireless range is 10 meters.

FIG. 2 is a block diagram of the present invention, in which the microprocessor (32) of the remote controller (30) is coupled with the control key (31), the security lamp (33), the alarm module (34) and the wireless circuit (35) of the remote controller (30). The microprocessor (32) of the remote controller (30) is able to turn on/off the alarm module (34), open the “In Range” security lamp (33), turn on/off the function of the wireless transmission and produce a search packet.

First Embodiment

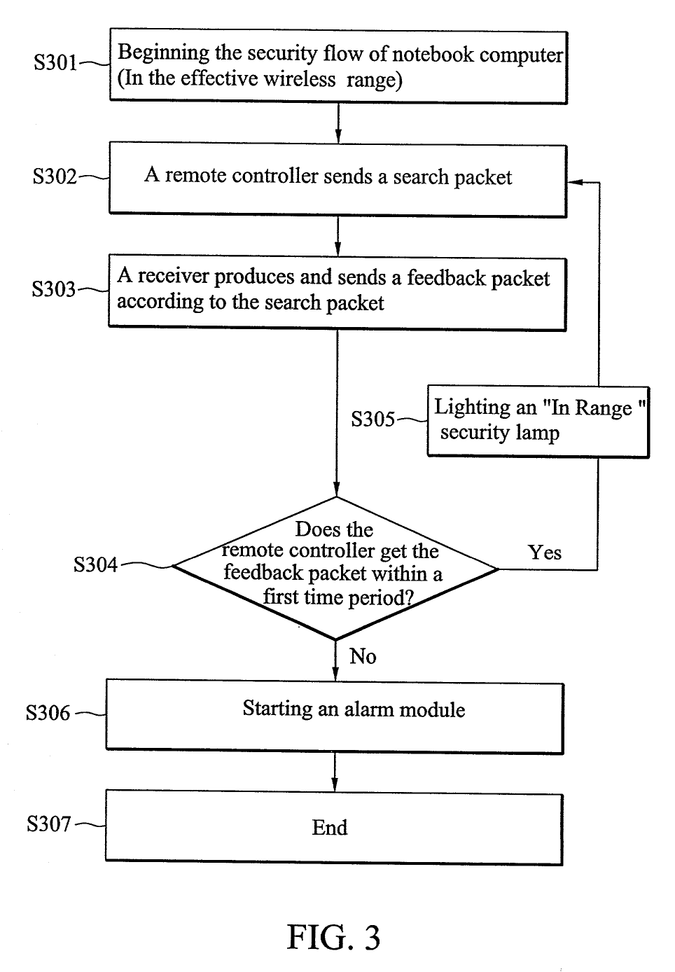

FIG. 3 is a flow diagram of the wireless security apparatus of an embodiment of the present invention.

The security method comprises the steps shown in FIG. 3. First, the notebook computer with the receiver (20) mentioned above begins the security flow within the effective wireless range (S301). The remote sends a search packet including a remote controller identity code (S302). When the receiver (20) gets the search packet and verifies the remote controller identity code, the receiver (20) produces and sends a feedback packet including a receiver identity code according to the search packet through wireless transmission (S303). After sending out the search packet, the remote controller (30) awaits receipt of the feedback packet within a first time period (S304). If the remote controller (30) gets the feedback packet with a correct receiver identity code within a first time period, the microprocessor of the remote controller (32) will light the “In Range” security lamp (33) (S305). It means that the notebook computer is within the security region (10 meters), or the effective wireless range. If the remote controller (30) doesn't get the feedback packet or gets a feedback packet with an incorrect receiver identity code within a first time period, the microprocessor (32) of the remote controller (30) activates the alarm module (34), lighting a lamp, producing a sound or a vibration (S306). These alarm signals warn the user that the notebook computer might be stolen or the user is outside the security region.

The first time period is a system-determined time period, depending on different processing speeds of microprocessors and different wireless transmission protocols. In this embodiment, the first time period is 1 second.

Second Embodiment

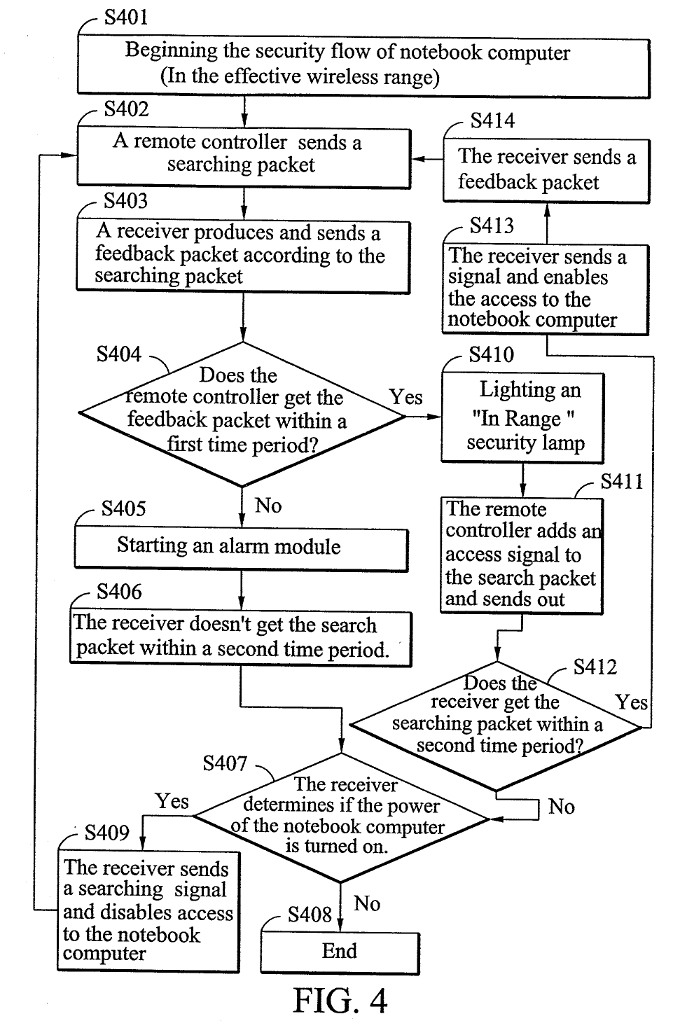

FIG. 4 is a flow diagram of the wireless security apparatus of another embodiment of the present invention.

The security method comprises the steps shown in FIG. 4. First, the notebook computer with the receiver (20) of the security apparatus mentioned above in the embodiment of the present invention begins the security flow within the effective wireless range (S401). The remote controller (30) sends a search packet including a remote controller identity code (S402). When the receiver (20) gets the search packet and verifies the remote controller identity code, the receiver (20) produces and sends a feedback packet including a receiver identity code according to the search packet through wireless transmission (S403). After sending out the search packet, the remote controller (30) awaits receipt of the feedback packet within a first time period (S404). If the remote controller (30) gets the feedback packet with a correct receiver identity code within a first time period, the microprocessor (32) of the remote controller (30) will light the “In Range” security lamp (33) (S410), indicating that the notebook computer is within the security region (10 meters).

The remote controller (30) also adds an access signal to the search packet and sends out (S411). After sending out the feedback packet, the receiver (20) awaits receipt of the search packet with the access signal and the remote controller identity code within a second time period (S412). If the receiver (20) gets the correct search packet with the access signal within a second time period, the receiver (20) will send out a signal to the chipset (12), or the Southbridge and the Northbridge, to power on the notebook computer, enable the notebook computer, or enable access to the notebook computer (S413). At the same time, the receiver (20) also sends a feedback packet (S414) and the flow turns back to the step of the remote controller (30) sending out the search packet (S402). The steps mentioned above are finished within several seconds.

Referring to FIG. 4, if the remote controller (30) doesn't get the feedback packet or gets a feedback packet with an incorrect receiver identity code within a first time period, the microprocessor (32) of the remote controller (30) activates the alarm module (34), lighting a lamp, producing a sound or a vibration (S405). The alarm signals warn the user that the notebook computer might be stolen or the user is out of the security region. When the receiver (20) of the security apparatus is unable to transmit the feedback packet to the remote controller (30) through the wireless transmission protocol, the remote controller (30) comparatively produces no search packet and the receiver (20) will not receive the search packet with the access signal mentioned above within a second time period (S406). The receiver (20) then determines if the notebook computer is turned on (S407). If so, the receiver (20) sends out a signal to the chipset (12), to disable access to the notebook computer and wait to receive the search packet from the remote controller (30) to repeat the above steps (S409). At the same time, if the notebook computer is turned off, the method of this embodiment is completed (S408).

The first time period and the second time period are system-determined time periods, depending on different processing speeds of microprocessors and different wireless transmission protocols. In this embodiment, the first time period and second time period are within 1 second.

It is to be understood that the present invention is not limited to the embodiments described above, but encompasses any and all embodiments within the scope of the following claims.

What is claimed is:

1. A security apparatus for a mobile electronic system, comprising:
a receiver of the mobile electronic system; and
a remote controller, connected to the receiver by a wireless transmission protocol, comprising a control module and an alarm module, wherein the control module activates the alarm module when the control module fails to connect to the receiver by wireless transmission within a first time period.

2. The security apparatus as claimed in claim 1, wherein when the mobile electronic system is turned on and the receiver establishes a connection to the remote controller by the wireless transmission protocol, the mobile electronic system enables access to the mobile electronic system.

3. The security apparatus as claimed in claim 1, wherein when the mobile electronic system is turned on and the receiver is unable to establish a wireless connection to the remote controller within a second time period, the mobile electronic system disables access to the mobile electronic system.

4. The security apparatus as claimed in claim 1, wherein the remote controller of the security apparatus also comprises:
a control key, for disabling the function of the wireless transmission protocol.

5. The security apparatus as claimed in claim 1, wherein the effective wireless range is 10 meters.

6. The security apparatus as claimed in claim 1, wherein the control module in a microprocessor.

7. The security apparatus as claimed in claim 1, wherein the alarm module is a LED.

8. The security apparatus as claimed in claim 1, wherein the alarm module is a speaker.

9. The security apparatus as claimed in claim 1, wherein the alarm module is a vibrator.

10. A security method for a security apparatus of a mobile electronic system, wherein a remote controller and a receiver of the security apparatus establishes a connection to each other by a wireless transmission protocol, comprising the steps of:
sending a search packet from the remote controller to the receiver by wireless transmission;
producing and sending a feedback packet according to the search packet from the receiver by wireless transmission after getting the search packet;
producing an alarm action at the remote controller when the remote controller is unable to receive the feedback packet within a first time period.

11. The security method as claimed in claim 10, also comprising the steps of:
enabling access to the mobile electronic system when the mobile electronic system is turned on and the receiver is able to receive the search packet.

12. The security method as claimed in claim 10, also comprising the steps of:
disabling access when the mobile electronic system is turned on and the receiver is unable to receive the feedback packet by wireless transmission within a second time period.

13. The security method as claimed in claim 10, wherein the remote controller can disable the wireless function.

14. The security apparatus as claimed in claim 10, wherein the effective wireless range is 10 meters.

15. The security apparatus as claimed in claim 10, wherein the search packet comprises a remote controller identity code.

16. The security method as claimed in claim 15, also comprising the steps of:
identifying the remote controller identity code of the search packet.

17. The security apparatus as claimed in claim 10, wherein the feedback packet comprises a receiver identity code.

18. The security method as claimed in claim 17, also comprising the steps of:
identifying the remote controller identity code of the search packet.

19. The security method as claimed in claim 10, wherein the alarm action is lighting a lamp.

20. The security method as claimed in claim 10, wherein the alarm action is producing a sound.

21. The security method as claimed in claim 10, wherein the alarm action is making a vibration.
